(19) United States
(12) Patent Application Publication
(10) Pub. No.: US 2024/0124356 A1
(43) Pub. Date: Apr. 18, 2024

(54) Packaged, Dry, Rapid-Hardening Cementitious Material for Concrete Repairs in Cold, Freezing, and Sub-Zero Temperature Conditions

(71) Applicant: Oldcastle APG, Inc., Atlanta, GA (US)

(72) Inventor: Dan Austin Plattenberger, Denver, CO (US)

(21) Appl. No.: 18/375,776

(22) Filed: Oct. 2, 2023

Related U.S. Application Data
(60) Provisional application No. 63/412,662, filed on Oct. 3, 2022.

(51) Int. Cl. C04B 28/06; C04B 24/06; C04B 40/00

(52) U.S. Cl. CPC C04B 28/065; C04B 24/06; C04B 40/0042; C04B 2103/14

(57) ABSTRACT

A formulation for a packaged, dry, cementitious concrete material for rapid repairs to hardened hydraulic-cement concrete pavements, structures, and other articles meets or exceeds the performance requirements of ASTM C928/C928M—20a for a type R3 concrete to be mixed and applied at or below 32° F. The formulation includes calcium sulfoaluminate cement; and a hardening accelerator that operates by contributing seeds of calcium-silicate-hydrate when the dry cementitious concrete material is mixed with water.

This application claims priority to U.S. provisional patent application 63/412,662, filed Oct. 3, 2022, incorporated herein by reference in its entirety.

### BACKGROUND

In the modern world, concrete is commonly prepared by mixing its dry ingredients—mainly aggregate in a range of sizes (e.g., sands and gravels) and cement (most commonly, Portland cement)—with water. This mixture, initially fluid, flowable, and workable, hardens, under appropriate “curing” conditions (generally, enough moisture/humidity and temperature), into a strong article or structure, the shape of which is generally imparted by a mold or a form into which the fresh, fluid mixture has been originally poured or pumped.

The existence of cool (e.g., 50° F.), or cold (e.g., 40° F.), or freezing (e.g., 32° F. or lower), or sub-zero (lower than 0° F.) ambient temperatures as fresh concrete cures raises significant considerations that must be addressed. Perhaps chief among these considerations is the avoidance of allowing the fresh concrete to freeze before it has attained a compressive strength of at least 500 psi. If the fresh concrete freezes before reaching this strength, its ability to attain its intended ultimate strength (e.g., 3000 psi or more) is lost.

The present invention generally concerns a formulation for concrete that, as it cures, will be exposed to cold, freezing, or sub-zero ambient weather conditions. More specifically, the present invention concerns a formulation for such concrete that is intended to be used to repair pre-existing concrete articles and/or structures in cold, freezing, or sub-zero ambient weather conditions. Even more specifically, the present invention concerns a formulation for the packaged, dry ingredients (the “mix” or “dry mix”) for preparing such concrete.

Certain concreting techniques have been developed for use in cold weather concreting applications, with limited and varying degrees of success.

For example, when temperatures are not too low, a technique of limited helpfulness is to heat one or more of the concrete ingredients—typically the sand and/or the gravel and/or the water—prior to installation. This heat input may be enough to overcome a brief, sub-freezing, dip in ambient temperature during the curing phase.

Another common technique is to tent the installation and to heat it—with, for example, space heaters—while the concrete is poured/pumped, worked, and cured. The efficacy of this technique depends on a wide variety of factors, and is often impractical, slow, and difficult to control.

Once activated, the chemical reactions between the cement and the water (“hydration”) in a standard hydraulic concrete mixture are exothermic—they generate a “heat of hydration”. So, insulating blankets are often laid over the freshly laid concrete to trap in the heat of hydration. But this technique is also of limited value—when external temperatures drop to 40° F., the hydration kinetics actually slow down and grind to a halt, so that there is little to no heat of hydration to trap with insulating blankets. (The same is true, even if one “puts more logs on the fire” by, for example, increasing the proportion of Portland cement in the mix (another common technique)—the resulting “larger fire” will put out more heat only for so long as the “logs burn”.)

Due to the limitations inherent in these techniques, modified concrete formulations have also been used in cold weather applications.

Some types of cement dissolve faster in water, gain strength faster, and give off more heat of hydration, than typical Portland cement (i.e., Type I, II, IV and/or V). See, for example, ASTM C150/C150M—22 Standard Specification for Portland Cement for a description of the ingredients, chemical compositions, and physical properties of these types of Portland cement, incorporated herein by reference and summarized in Section B of the Detailed Description below; and ASTM C150/C150M—20a, incorporated herein by reference and summarized in Section B of the Detailed Description below, including the other documents referenced in it. So concrete formulations for cold weather use have substituted these faster strength gain cement types—for example, Type III Portland cement, or calcium sulfoaluminate cement (“CSA”). See, for example, Buzzi Unicem USA product brochure for CSA and incorporated herein by reference and summarized in Section B of the Detailed Description below, or a suitable blend of calcium aluminate cement and calcium sulfate—for some or all of the typical Portland cement. It is generally possible, with varying degrees of success, to use this approach to safely cure the concrete in ambient temperatures down to about 20° F.

Another common formulation for cold weather concreting is to include an “accelerating” admixture into the mix. These accelerators are commonly chloride-based materials (such as, for example, calcium chloride), but can be non-chloride-based materials (such as, for example, calcium formate). These common admixtures dissolve in the water, freeing ions to chemically initiate strength-gain, or strength-gain precursor activity not commonly occurring in their absence. Maintaining adequate strength gain in ambient temperatures as low as about 20° F. seems to be the limit for this technique as well, as the colder temperatures inhibit the requisite dissolution processes of both the cement and the admixtures.

Fairly recently (2019), BASF Construction Additives GmbH (“BASF”) has introduced a line of accelerator products for “ordinary Portland cement” under the name “HyCon® S”. This line of products apparently works on a different principle than the accelerating admixtures described above. BASF describes this line of products as based on “calcium-silicate-hydrate (C-S-H) seeding technology”. According to BASF, the HyCon® S products work by, “lowering the energetic barrier of the crystallization process of C-S-H by contributing seeds of C-S-H. By adding HyCon® S two processes are initiated: □Immediate start of formation of calcium-silicate-hydrate□C-S-H formation also in the space between clinker grains (not only on clinker surface)”. (The quoted material is excerpted from BASF's Technical Leaflet entitled HyCon® S Technology, dated December 2019, which, together with its contents, is incorporated herein by reference and summarized in Section B of the Detailed Description below.) The Technical Leaflet includes a bar chart entitled, “Impact of temperature on strength at different dosages”, that shows strength accelerating properties of one of the HyCon® S products (7042 F) in a Portland cement-based mortar at a temperature as low as 5° C. (41° F.). (BASF's Preliminary Technical Data Sheet, dated June 2019, is incorporated herein by reference and summarized in Section B of the Detailed Description below.)

There still exists a need for a relatively inexpensive concrete formulation for use in freezing, and, especially, in sub-zero conditions.

### SUMMARY OF THE INVENTION

The inventor has developed a novel concrete formulation that meets and exceeds the performance requirements of ASTM C928/M928—20a R3 concrete or mortar at curing temperatures at least as low 0° F. (−17.8° C.). ASTM C928/C928M—20a Standard Specification for Packaged, Dry, Rapid-Hardening Cementitious Materials for Concrete Repairs is a representative description of commonly accepted performance requirements for packaged, dry cementitious materials for concrete repair, namely, compressive strength gain, bond strength gain, length change, consistency (slump and flow), and scaling resistance to deicing chemicals. ASTM C928/C928M—20a is incorporated herein by reference, together the other documents referenced in it and summarized in Section B of the Detailed Description below.

In general, a formulation for a packaged, dry, cementitious concrete material for rapid repairs to hardened hydraulic-cement concrete pavements, structures, and other articles is provided. The formulation meets or exceeds the performance requirements of ASTM C928/C928M—20a for a type R3 concrete to be mixed and applied at or below 32° F., said formulation comprising: calcium sulfoaluminate cement; and a hardening accelerator that operates by contributing seeds of calcium-silicate-hydrate when the dry cementitious concrete material is mixed with water.

Preferably, the formulation meets or exceeds the performance requirements of ASTM C928/C928M—20a for a type R3 concrete to be mixed and applied at 0° F.

Preferably, the formulation includes no Portland cement.

### DETAILED DESCRIPTION

### A. Description of the Preferred Embodiment(s)

The following dry ingredients, in the proportions noted, comprise a preferred formulation for a packaged, dry, rapid-hardening cementitious material for concrete repairs:
Calcium sulfoaluminate cement (“CSA”), or a suitable mixture of calcium aluminate cement and calcium sulfate, (15-40% wt.)
   This is the cementitious component of the formulation
Citric acid or tartaric acid (0.05-0.2% wt.)
   These materials are interchangeable and are present to briefly retard the set time of the repair concrete to permit its placement
R+D HyCon® S 7042F (0.1-1.0% wt.)
   C-S-H seeding technology-based hardening accelerator developed by BASF for use in Portland cement—based mortars
Commercial plasticizer/superplasticizer (0-0.5% wt.)
   One suitable example of which is BASF's “Melment® F 10”. The Technical Data Sheet for this product is incorporated herein by reference and summarized in Section B of the Detailed Description below
   As needed to reduce stickiness imparted by the R+D HyCon® S 7042F and to reduce water
Black pigment (0.05—0.2% wt.)
   Optional, for appearance only
Aggregates (balance)
   Conventional sands and gravels in proportions that can be varied for different repair applications

This preferred formulation includes no Portland cement.

When 50 pounds of this preferred formulation of blended, dry ingredients is mixed with 2 quarts (1.9 liters) of water. The resulting concrete will exceed the ASTM C928 performance requirements for mixing, application, and the first three hours of curing at 0° F.: It has a slump of 3″, an initial set time of approximately 15 minutes, a final set time of approximately 30 minutes, and achieves a 3 hour strength of >4000 psi, all in 0° F. ambient conditions; it achieves a 1 day strength of >7000 psi, a 7 day strength of >9000 psi, and a 28 day strength of >9000 psi and has a 28 day length change wet sample of <0.04%, a 28 day length change dry sample of <−0.05%, all under the conditions prescribed in C928. This concrete also meets or surpasses the bond strength and scaling resistance requirements of C928. The inventor is not aware of any other concrete formulation that can achieve these extreme weather performance traits, either for original use, or for repair use.

For less stringent curing temperatures than sub-zero, the proportions of CSA cement and HyCon S can be moderated. The proportions of fine and course aggregates can be varied to prepare concrete, mortar, or grout formulations.

### B. Standards, Materials, and Technical Data Used for the Preferred Embodiments

### Standard Specification for Portland Cement

This standard is issued under the fixed designation C150/C150M; the number immediately following the designation indicates the year of original adoption or, in the case of revision, the year of last revision. A number in parentheses indicates the year of last reapproval. A superscript epsilon indicates an editorial change since the last revision or reapproval.

### 1. Scope*

1.1 This specification covers ten types of portland cement, as follows (see Note 2): 1.1.1 Type I For general use, when the special properties specified for any other type are not required.

1.1.2 Type IA Air-entraining cement for the same uses as Type I, where air-entrainment is desired. 1.1.3 Type II For general use, more especially when moderate sulfate resistance is desired.

1.1.4 Type IIA Air-entraining cement for the same uses as Type II, where air-entrainment is desired.

1.1.5 Type II(MH) For general use, more especially when moderate heat of hydration and moderate sulfate resistance are desired.

1.1.6 Type II(MH)A Air-entraining cement for the same uses as Type II(MH), where air-entrainment is desired.

1.1.7 Type III For use when high early strength is desired.

1.1.8 Type IIIA Air-entraining cement for the same use as Type III, where air-entrainment is desired.

1.1.9 Type IV For use when a low heat of hydration is desired.

1.1.10 Type V For use when high sulfate resistance is desired.

NOTE 1—Some cements are designated with a combined type classification, such as Type I/II, indicating that the cement meets the requirements of the indicated types and is being offered as suitable for use

when either type is desired.

NOTE 2—Cement conforming to the requirements for all types are not carried in stock in some areas. In advance of specifying the use of cement other than Type I, determine whether the proposed type of cement is or can be made available.

1.2 The values stated in either SI units or inch-pound units are to be regarded separately as standard. The values stated in each system may not be exact equivalents; therefore, each system shall be used independently of the other. Combining values from the two systems may result in non-conformance with the standard. Values in SI units [or inch-pound units] shall be obtained by measurement in SI units [or inch-pound units] or by appropriate conversion, using the Rules for Conversion and Rounding given in IEEE/ASTM SI 10, of measurements made in other units [or SI units]. Values are stated in only SI units when inch-pound units are not used in practice.

1.3 The text of this specification references notes and footnotes which provide explanatory material. These notes and footnotes (excluding those in tables and figures) shall not be considered as requirements of the standard.

1.4 This international standard was developed in accordance with internationally recognized principles on standardization established in the Decision on Principles for the Development of International Standards, Guides and Recommendations issued by the World Trade Organization Technical Barriers to Trade (TBT) Committee.

### 2. Referenced Documents

2.1 ASTM Standards:2

C51 Terminology Relating to Lime and Limestone (as Used by the Industry)

C109/C109M Test Method for Compressive Strength of Hydraulic Cement Mortars (Using 2-in. or [50 mm] Cube Specimens)

C114 Test Methods for Chemical Analysis of Hydraulic Cement

C183/C183M Practice for Sampling and the Amount of Testing of Hydraulic Cement

C185 Test Method for Air Content of Hydraulic Cement Mortar

C191 Test Methods for Time of Setting of Hydraulic Cement by Vicat Needle

C204 Test Methods for Fineness of Hydraulic Cement by Air-Permeability Apparatus

C219 Terminology Relating to Hydraulic and Other Inorganic Cements

C226 Specification for Air-Entraining Additions for Use in the Manufacture of Air-Entraining Hydraulic Cement

C266 Test Method for Time of Setting of Hydraulic-Cement Paste by Gillmore Needles

C451 Test Method for Early Stiffening of Hydraulic Cement (Paste Method)

C452 Test Method for Potential Expansion of Portland-Cement Mortars Exposed to Sulfate

C465 Specification for Processing Additions for Use in the Manufacture of Hydraulic Cements

C563 Guide for Approximation of Optimum SO3 in Hydraulic Cement

C1038/C1038M Test Method for Expansion of Hydraulic Cement Mortar Bars Stored in Water

C1702 Test Method for Measurement of Heat of Hydration of Hydraulic Cementitious Materials Using Isothermal Conduction Calorimetry

C1778 Guide for Reducing the Risk of Deleterious Alkali-Aggregate Reaction in Concrete E29 Practice for Using Significant Digits in Test Data to Determine Conformance with Specifications IEEE/ASTM SI 10 American National Standard for Metric Practice

### 3. Terminology

3.1 Definitions:

3.1.1 For definitions pertinent to this specification, see Terminology C219.

### 4. Ordering Information

4.1 Orders for material under this specification shall include the following:

4.1.1 This specification number and date,

4.1.2 Type or types allowable. If no type is specified, Type I shall be supplied,

4.1.3 Any optional chemical requirements from Table 2, if desired, and

4.1.4 Any optional physical requirements from Table 4, if desired.

### 5. Ingredients

5.1 The cement covered by this specification shall contain no ingredients except as follows:

5.1.1 Portland Cement Clinker.

5.1.2 Water or Calcium Sulfate, or Both The amounts shall be such that the limits shown in Table 1 for sulfur trioxide and loss-on-ignition are not exceeded.

5.1.3 Limestone The amount shall not be more than 5.0% by mass such that the chemical and physical requirements of this specification are met (see Note 3). The limestone, defined in Terminology C51, shall be naturally occurring and consist of at least 70% by mass of one or more of the mineral forms of calcium carbonate. If limestone is used, the manufacturer shall report the amount used, expressed as a percentage of cement mass, as determined using Annex A2, along with the oxide composition of the limestone.

NOTE 3—This specification permits portland cement to contain limestone, but does not require that limestone be an ingredient in the cement. Cement without ground limestone can be specified in the contract or order.

TABLE 1
Standard Composition Requirements

| | Applicable | | | | | | |
|---|---|---|---|---|---|---|---|
| Cement Type [symbol] | Test Method | I and IA | II and IIA | [symbol] and [symbol] | III and IIIA | IV | V |
| Aluminum oxide (Al₂O₂), max, % | [symbol] | [symbol] | [symbol] | [symbol] | [symbol] | [symbol] | [symbol] |
| [symbol] oxide (F [symbol] ₂O₂), max, % | [symbol] | [symbol] | [symbol] | [symbol] | [symbol] | [symbol] | [symbol] |
| Magnesium oxide (Mg [symbol] ), max, % | [symbol] | [symbol] | [symbol] | [symbol] | [symbol] | [symbol] | [symbol] |
| Sulfur trioxide ( [symbol] O [symbol] ), [symbol] max, % | [symbol] | | | | | | |
| When (C [symbol] A) [symbol] % or less | | [symbol] | 3.0 | 3.0 | [symbol] | 2.3 | [symbol] |
| When (C [symbol] A) [symbol] is more than 8% | | [symbol] | [symbol] | [symbol] | 4.5 | [symbol] | [symbol] |
| [symbol] on [symbol] , max, % | [symbol] | | | | | | |
| When limestone is not an ingredient | | [symbol] | 3.0 | 3.0 | 3.0 | 2.5 | 3.0 |
| When limestone is an ingredient | | 3.5 | 3.5 | 3.5 | 3.5 | 3.5 | 3.5 |
| Insoluble [symbol] , max, % | [symbol] | 1.5 | 1.5 | 1.5 | 1.5 | 1.5 | 1.5 |
| Equivalient [symbol] (Na [symbol] O + [symbol] ) [symbol] K [symbol] O [symbol] , % | [symbol] | [symbol] | [symbol] | [symbol] | [symbol] | [symbol] | [symbol] |
| Tricalcium [symbol] (C [symbol] ), [symbol] max, % | See [symbol] A1 | [symbol] | [symbol] | [symbol] | [symbol] | [symbol] | [symbol] |
| Dicalcium [symbol] (C [symbol] A), [symbol] min, % | See [symbol] A1 | [symbol] | [symbol] | [symbol] | [symbol] | [symbol] | [symbol] |
| Tricalcium [symbol] (C [symbol] A), [symbol] max, % | See [symbol] A1 | [symbol] | 8 | 8 | 15 | [symbol] | [symbol] |
| Sum [symbol] C [symbol] S [symbol] + 4.7 [symbol] (C [symbol] A), [symbol] max, % | See [symbol] A1 | [symbol] | [symbol] | [symbol] | [symbol] | [symbol] | [symbol] |
| Tetracalcium [symbol] plus twice the | See [symbol] A1 | [symbol] | [symbol] | [symbol] | [symbol] | [symbol] | [symbol] |
| [symbol] aluminare (C [symbol] AF + 2(C [symbol] A)), [symbol] | | | | | | | |
| solid solution (C [symbol] AF + C [symbol] F), | | | | | | | |
| [symbol] applicable, max, % | | | | | | | |

[symbol]

See Note 2. [symbol]
Does not apply when the sulfate [symbol] limit in Table 4 is specified. [symbol]
Does not apply when the cement complies with the heat of hydration limit in Table 4. [symbol]
It is permissible to exceed the values in the table for [symbol] O [symbol] content, provided it has been demonstrated by Test Method [symbol] that the cement with the increased SO [symbol] will not develop expansion exceeding 0.0220 [symbol] at 14 days. When the manufacturer supplies cement under this provision, supporting data shall be supplied to the purchaser (see Note 7). [symbol]
See [symbol] A1 for calculation. [symbol]
Not applicable. [symbol]
Report equivalent [symbol] as part of the manufacturer’s certification (See Note [symbol] ). [symbol]
See Note [symbol] . [symbol]
In addition, [symbol] -day heat of hydration treating by Test Method [symbol] shall be constructed at least once every six months. Such testing shall not be used for acceptance or rejection of the cement, but results shall be reported for [symbol] purposes. [symbol]
indicates data missing or illegible when filed

TABLE 3
Standard Physical Requirements

| | Applicable | | | | | | | | | | |
|---|---|---|---|---|---|---|---|---|---|---|---|
| Cement Type [symbol] | Test Method | I | IA | II | IIA | [symbol] | [symbol] | III | IIIA | IV | V |
| Air content of [symbol] , [symbol] volumne [symbol] | C185 | | | | | | | | | | |
| max | | 12 | 22 | 12 | 22 | 12 | 22 | 12 | 22 | 12 | 12 |
| min | | [symbol] | [symbol] | [symbol] | [symbol] | [symbol] | [symbol] | [symbol] | [symbol] | [symbol] | [symbol] |
| [symbol] , specific surface, m²/kg | | | | | | | | | | | |
| Air [symbol] test | C20 [symbol] | | | | | | | | | | |
| min | | [symbol] | [symbol] | [symbol] | [symbol] | [symbol] | [symbol] | [symbol] | [symbol] | [symbol] | [symbol] |
| max | | [symbol] | [symbol] | [symbol] | [symbol] | [symbol] | [symbol] | [symbol] | [symbol] | [symbol] | [symbol] |
| Strength, not less than the values | | | | | | | | | | | |
| shown for the ages indicated as [symbol] | | | | | | | | | | | |
| Compressive strength, Mpa [symbol] psi [symbol] | C [symbol] | | | | | | | | | | |
| 1 day | C [symbol] | [symbol] | [symbol] | [symbol] | [symbol] | [symbol] | [symbol] | 12.0 | 10.0 | [symbol] | [symbol] |
| | | | | | | | | [1740] | [1450] | | |
| 3 days | | 12.0 | 10.0 | 10.0 | 8.0 | 10.0 | 8.0 | 24. [symbol] | [symbol] | [symbol] | 8.0 |
| | | [1740] | [1450] | [1450] | [ [symbol] ] | [1450] | [ [symbol] ] | [ [symbol] ] | [ [symbol] ] | | [ [symbol] ] |
| 7 days | | [symbol] | 16.0 | 17.0 | 14.0 | 17.0 | 14.0 | [symbol] | [symbol] | 7.0 | 15.0 |
| | | [ [symbol] ] | [2320] | [2470] | [ [symbol] ] | [2470] | [ [symbol] ] | | | [1020] | [2180] |
| 28 days | | [symbol] | [symbol] | [symbol] | [symbol] | [symbol] | [symbol] | [symbol] | [symbol] | 17.0 | 21.0 |
| | | | | | | | | | | [2470] | [ [symbol] ] |
| Time of setting, [symbol] test [symbol] | C [symbol] | | | | | | | | | | |
| Time of seting, minutes, | | 45 | 45 | 45 | 45 | 45 | 45 | 45 | 45 | 45 | 45 |
| not less than | | | | | | | | | | | |
| Time of setting, minutes, | | 375 | 375 | 375 | 375 | 375 | 375 | 375 | 375 | 375 | 375 |
| not more than | | | | | | | | | | | |

[symbol]

See Note 2. [symbol]
Compliance with the requirements of this specification does not necessarily ensure that the desired air content will be obtained in concreate. [symbol]
Maximum [symbol] limits do not apply if the sum of C [symbol] S [symbol] + 4.75(C [symbol] A) is less than or equal to [symbol] 0, or the cement complies with the heat of hydration limit in Table 4. [symbol]
The strength at any specified test age shall be not less then that attained at any previous specified test age. [symbol]
The time of setting is that described as initial setting time in Test Method [symbol] . [symbol]
indicates data missing or illegible when filed

TABLE 2
Optinal Composition Requirements

[symbol]

| | Applicable | | | | | | | |
|---|---|---|---|---|---|---|---|---|
| Cement Type | Test method | I and IA | II and IA | [symbol] and [symbol] | III and IIIA | IV | V | Remarks |
| Tricalcium aluminate (C [symbol] A), [symbol] max, % | See [symbol] A1 | [symbol] | [symbol] | [symbol] | [symbol] | [symbol] | [symbol] | For moderate [symbol] resistance. |
| Tricalcium aluminate (C [symbol] A), [symbol] max, % | See [symbol] A1 | [symbol] | [symbol] | [symbol] | [symbol] | [symbol] | [symbol] | For high [symbol] resistance. |

[symbol]

These optional requirements apply only when specifically requested. Verify availability before ordering (see Note 2). [symbol]
See [symbol] A1 for calculation. [symbol]
indicates data missing or illegible when filed

TABLE 4
Optional Physical Requirements

[symbol]

| | Applicable | | | | | | | | |
|---|---|---|---|---|---|---|---|---|---|
| Cement Type | Test method | I and II | IA and IA | [symbol] | [symbol] | III | IIIA | IV | V |
| Early [symbol] , [symbol] penetration, min, % | C [symbol] | [symbol] | [symbol] | [symbol] | [symbol] | [symbol] | [symbol] | [symbol] | [symbol] |
| Heat of hydration | | | | | | | | | |
| [symbol] Conduction [symbol] | | | | | | | | | |
| 3 days, max, kJ [symbol] [ [symbol] /g] | C1702 | [symbol] | [symbol] | [symbol] [ [symbol] ] [symbol] | [symbol] [ [symbol] ] [symbol] | [symbol] | [symbol] | 200 [ [symbol] ] [symbol] | [symbol] |
| 7 days, max, kJ [symbol] [ [symbol] /g] | | [symbol] | [symbol] | [symbol] | [symbol] | [symbol] | [symbol] | 225 [ [symbol] ] [symbol] | [symbol] |
| Strength, not less than [symbol] values shown: | | | | | | | | | |
| Compressive strength, MPa [ [symbol] ] | C [symbol] /C [symbol] | | | | | | | | |
| 28 days | | [symbol] | 22.0 | [symbol] | 22.0 | [symbol] | [symbol] | [symbol] | [symbol] |
| | | [ [symbol] ] | [3190] | [ [symbol] ] | [3190] | | | | |
| [symbol] resistance, [symbol] 14 days, max, % expansion | C [symbol] | [symbol] | [symbol] | [symbol] | [symbol] | [symbol] | [symbol] | [symbol] | 0.040 |
| [symbol] | C [symbol] | | | | | | | | |
| Initial [symbol] . min, not less than | | [symbol] | [symbol] | [symbol] | [symbol] | [symbol] | [symbol] | [symbol] | [symbol] |
| Final [symbol] . min, not more than | | [symbol] | [symbol] | [symbol] | [symbol] | [symbol] | [symbol] | [symbol] | [symbol] |

[symbol]

These optional requirements apply only when specifically requested. Verify availability before ordering (see Note 2). [symbol]
The limit for the sum of C [symbol] S + 4.75(C [symbol] A) in Table 1 shall not apply when the cement complies with this limit. [symbol]
The limits of C [symbol] S, C [symbol] S, C [symbol] A and F [symbol] O [symbol] in Table 1 shall not apply when the cement complies with this limit. [symbol]
When the sulfate [symbol] is specified, it shall be [symbol] at the limits of C [symbol] A, C [symbol] AF + 2(C [symbol] A), and F [symbol] O [symbol] listed in Table 1. [symbol]
Cement [symbol] the high sulfate resistance limit for Type V is [symbol] to meet the moderate sulfate resistance requirements of Type II and Type [symbol] . [symbol]
indicates data missing or illegible when filed

5.1.4 Inorganic Processing Additions The amount shall be not more than 5.0% by mass of cement. Not more than one inorganic processing addition shall be used at a time. For amounts greater than 1.0%, they shall have been shown to meet the requirements of Specification C465 for the inorganic processing addition in the amount used or greater. If an inorganic processing addition is used, the manufacturer shall report the amount used, expressed as a percentage of cement mass, along with the oxide composition of the processing addition (see Note 4).

NOTE 4—These requirements are based on data and recommendations by Taylor.3

5.1.5 Organic Processing Additions They shall have been shown to meet the requirements of Specification C465 in the amounts used or greater and the total amount of organic processing additions used shall not exceed 1.0% by mass of cement.

5.1.6 Air-entraining Addition (for Air-entraining Portland Cement Only) The interground addition shall conform to the requirements of Specification C226.

### 6. Chemical Composition

6.1 Portland cement of each of the ten types shown in Section 1 shall conform to the respective standard chemical requirements prescribed in Table 1. In addition, optional chemical requirements are shown in Table 2.

NOTE 5—The standard composition requirements in Table 1 require reporting of equivalent alkalies. Cements with a maximum of 0.60% equivalent alkalies were historically designated as “low-alkali cements” and recommended for use with aggregates susceptible to alkali-silica reaction (ASR). However, low-alkali cements (in the absence of other mitigation measures) may not be effective in mitigating ASR. Guidance on formulating concrete mixtures, including calculating alkali loading using equivalent alkali content of cement to minimize the potential for ASR, is provided in Guide C1778.

NOTE 6—The limit on the sum, C3S+4.75(C3A), in Table 1 provides control on the heat of hydration of the cement and is consistent with a Test Method C1702 three-day heat of hydration limit of 315 kJ/kg [75 cal/g].

NOTE 7—There are cases where performance of a cement is improved with SO3 in excess of the Table 1 limits in this specification. Guide C563 is one of several methods a manufacturer can use to evaluate the effect of sulfate content on cement characteristics. Whenever SO3 content of a cement exceeds Table 1 limits, Test Method C1038/C1038M results provide evidence that excessive expansion does not occur at this higher sulfate content.

### 7. Physical Properties

7.1 Portland cement of each of the ten types shown in Section 1 shall conform to the respective standard physical requirements prescribed in Table 3. In addition, optional physical requirements are shown in Table 4.

### 8. Sampling

8.1 When the purchaser desires that the cement be sampled and tested to verify compliance with this specification, perform sampling and testing in accordance with Practice C183/C183M.

8.2 Practice C183/C183M is not designed for manufacturing quality control and is not required for manufacturer's certification.

### 9. Test Methods

9.1 Determine the applicable properties enumerated in this specification in accordance with the following test methods:

9.1.1 Chemical Analysis Test Methods C114.

9.1.2 Air Content of Mortar Test Method C185.

9.1.3 Fineness by Air Permeability Test Method C204.

9.1.4 Strength Test Method C109/C109M.

9.1.5 Time of Setting by Vicat Needles Test Method C191.

9.1.6 Early Stiffening Test Method C451.

9.1.7 Heat of Hydration Test Method C1702.

9.1.8 Sulfate Resistance Test Method C452 (sulfate expansion).

9.1.9 Time of Setting by Gillmore Needles Test Method

C266.

9.1.10 Calcium Sulfate (Expansion of) Mortar Test

Method C1038/C 1038M.

### 10. Inspection

10.1 Inspection of the material shall be made as agreed upon between the purchaser and the seller as part of the purchase contract.

### 11. Rejection

11.1 The cement shall be rejected if it fails to meet any of the requirements of this specification.

11.2 At the option of the purchaser, retest, before using, cement remaining in bulk storage for more than six months or cement in bags in local storage in the custody of a vendor for more than three months after completion of tests and reject the cement if it fails to conform to any of the requirements of this specification. Cement so rejected shall be the responsibility of the owner of record at the time of resampling for retest.

11.3 Packages shall identify the mass contained as net weight. At the option of the purchaser, packages more than 2% below the mass marked thereon shall be rejected and if the average mass of packages in any shipment, as shown by determining the mass of 50 packages selected at random, is less than that marked on the packages, the entire shipment shall be rejected.

### 12. Manufacturer's Statement

12.1 At the request of the purchaser, the manufacturer shall state in writing the nature, amount, and identity of any air-entraining addition and of any processing addition used, and also, if requested, shall supply test data showing compliance of such air-entraining addition with Specification C226 and of such processing addition with Specification C465.

12.2 When limestone is used, the manufacturer shall state in writing the amount thereof and, if requested by the purchaser, shall supply comparative test data on chemical and physical properties of the cement with and without the limestone (see Note 8). The comparative tests do not supersede the normal testing to confirm that the cement meets chemical and physical requirements of this specification. The amount of limestone in cement shall be determined in accordance with Annex A2. by the manufacturer during formulation of the cement with limestone.

12.3 At the request of the purchaser, the manufacturer shall report the chloride content as determined using Test Methods C114, in percent by mass of the cement, in the manufacturer's report (see Note 9).

NOTE 9—Chlorides in concrete come from multiple ingredients and cement chloride content may be required to estimate concrete chloride content. Requirements for concrete chloride content are provided in building codes and other documents.

### 13. Packaging and Package Marking

13.1 When the cement is delivered in packages, the words “Portland Cement,” the type of cement, the name and brand of the manufacturer, and the mass of the cement contained therein shall be plainly marked on each package. When the cement is an air-entraining type, the words “air-entraining” shall be plainly marked on each package. Similar information shall be provided in the shipping documents accompanying the shipment of packaged or bulk cement. All packages shall be in good condition at the time of inspection.

NOTE 10—With the change to SI units, it is desirable to establish a standard SI package for portland cements. To that end 42 kg [92.6 lb] provides a convenient, even-numbered mass reasonably similar to the traditional 94-lb [42.6 kg] package.

### 14. Storage

14.1 The cement shall be stored in such a manner as to permit easy access for proper inspection and identification of each shipment, and in a suitable weather-tight building that will protect the cement from dampness and minimize warehouse set.

### 15. Manufacturer's Certification

15.1 Upon request of the purchaser in the contract or order, a manufacturer's report shall be furnished at the time of shipment stating the results of tests made on samples of the material taken during production or transfer and certifying that the cement conforms to applicable requirements of this specification.

NOTE 11—Guidance on preparing the manufacturer's report is provided in Appendix X1.

### 16. Keywords

16.1 hydraulic cement; portland cement; specification

### ANNEXES

### Mandatory Information

### A1. CALCULATION OF POTENTIAL CEMENT PHASE COMPOSITION

A1.1 All values calculated as described in this annex shall be rounded in accordance with Practice E29. When evaluating conformance to a specification, round values to the same number of places as the corresponding table entry before making comparisons. The expressing of chemical limitations by means of calculated assumed phases does not necessarily mean that the oxides are actually or entirely present as such phases.

A1.2 When expressing phases, C=CaO, S=SiO2, A=Al2O3, F=Fe2O3. For example, C3A=3CaO.Al2O3. Titanium dioxide and phosphorus pentoxide (TiO2 and P2O5) shall not be included with the Al2O3 content (see Note A1.1).

NOTE A1.1—When comparing oxide analyses and calculated phases from different sources or from different historic times, be aware that they may not have been reported on exactly the same basis. Chemical data obtained by Reference and Alternate Test Methods of Test Methods C114 (wet chemistry) may include titania and phosphorus as alumina unless proper correction has been made (see Test Methods C114), while data obtained by rapid instrumental methods usually do not. This can result in small differences in the calculated phases. Such differences are usually within the precision of the analytical methods, even when the methods are properly qualified under the requirements of Test Methods C114.

A1.3 When the ratio of percentages of aluminum oxide to ferric oxide is 0.64 or more, the percentages of tricalcium silicate, dicalcium silicate, tricalcium aluminate, and tetracalcium aluminoferrite shall be calculated from the chemical analysis as follows:

Tricalcium silicate (C3S)=(4.071×% CaO)−(7.600×% SiO2)−(6.718×% Al2O3)−(1.430×% Fe2O3)—(2.852×% SO3) (A1.1)

Dicalcium silicate (C2S)=(2.867×% SiO2)—(0.7544×% C3S) (A1.2)

Tricalcium aluminate (C3A)=(2.650×% Al2O3)—(1.692×% Fe2O3) (A1.3)

Tetracalcium aluminoferrite (C4AF)=3.043×% Fe2O3 (A1.4)

A1.3.1 When the alumina-ferric oxide ratio is less than 0.64, a calcium aluminoferrite solid solution (expressed as ss(C4AF+C2F)) is formed. No tricalcium aluminate will be present in cements of this composition. Dicalcium silicate shall be calculated as in Eq A1.2. Contents of this solid solution and of tricalcium silicate shall be calculated by the following formulas:

ss(C4AF+C2F)=(2.100×% Al2O3)+(1.702×% Fe2O3) (A1.5) Tricalcium silicate (C3 S)=(4.071×% CaO)—(7.600×% SiO2)—(4.479×% Al2O3)—(2.859×% Fe2O3)−(2.852×% SO3) (A1.6)

A1.4 If no limestone or inorganic processing additions are used in the cement, or in the absence of information on limestone or inorganic processing additions use in the cement, phases shall be calculated using procedures in Eq A1.1-A1.6 without adjustment.

A1.5 In absence of information on limestone or inorganic processing additions content, results shall note that no adjustment has been made for possible use of limestone or inorganic processing additions.

A1.6 When inorganic processing additions or limestone, or both, are used with the base cement (portland cement clinker and any added calcium sulfate), the contents of C3S, C2S, C3A, and C4AF shall be adjusted as follows:

A1.6.1 The percentage of C3S, C2S, C3A, and C4AF in the base cement (see Note A1.2) shall be determined based on chemical analyses using methods in Test Methods C114 and using Eq A1.1-A1.6 as appropriate. The contents of each of these phases shall be adjusted to account for the use of limestone or inorganic processing additions as follows:

$${X}_{f} = {X}_{s} \times \frac{( 100 - L - P )}{100} \qquad ( A1 \text{.7} )$$

where:

Xb=the percentage by mass of C3S, C2S, C3A, or C4AF in the base cement (portland cement clinker and any calcium sulfate), L=the percentage by mass of limestone, P=the percentage by mass of inorganic processing addition, and Xf=the percentage by mass of C3 S, C2S, C3A, or C4AF in the finished cement.

NOTE A1.2—Where the oxide analysis of the finished cement, the limestone, and inorganic processing addition are known along with the mass percentage of limestone (L) and mass percentage of inorganic processing addition (P), one method of determining the base cement oxide composition is to use the following equation:

Ob=100×(Of−(L 100×Ol)−(P/100×Op))/(100−L−P)

where:

Ob=the base cement oxide content (% by mass of base cement), Of=the finished cement oxide content (% by mass of finished cement), Ol=the limestone oxide content (% by mass of limestone), and Op=the inorganic processing addition oxide content (% by mass of inorganic processing addition).

The base cement phase composition can be determined using these values of oxide analyses in Eq A1.1-A1.6. Eq A1.7 is used to calculate the adjusted phase composition. NOTE A1.3—For example, where the cement includes 3.5% limestone and 3.0% of an inorganic processing addition and the base cement has 60% C3S, 15% C2S, 7% C3A, and 10% C4AF, the adjusted phase composition is:

$${C}_{3} {S}_{f} = \frac{60 \times ( 100 - 3.5 - 3. )}{100} = 56 \% \\ {C}_{2} {S}_{f} = \frac{15 \times ( 100 - 3.5 - 3. )}{100} = 14 \% \\ {C}_{3} {A}_{f} = \frac{7 \times ( 100 - 3.5 - 3. )}{100} = 7 \% \\ {C}_{4} {AF}_{j} = \frac{10 \times ( 100 - 3.5 - 3. )}{100} = 9 \%$$

A1.6.2 Only the percentages of C3S, C2S, C3A, and C4AF shall be adjusted by the procedure in A1.6.1. These adjusted values for the finished cement shall be reported on the manufacturer's report, and used in determining compliance with specification limits, including those based on calculated values, such as the sums of C3S+4.75(C3A), and C4AF+2(C3A).

### A2. LIMESTONE CONTENT OF PORTLAND CEMENT

A2.1 When limestone is used, the limestone content in portland cement shall be derived from the determination of CO2 in the finished cement. Analysis of CO2 shall be based on methods described in Test Methods C114. The percent limestone in the cement is calculated from the CO2 analysis based on the CO2 content of the limestone used. The manufacturer shall include the CO2 content and calculated limestone content of the cement on the Mill Test Report.

The limestone content of the cement is calculated as follows:

$$\frac{\% {CO}_{2} in the cement}{\% {CO}_{2} in the limestone} \times 100 = \% limestone in cement$$

% CO2 in the cement

% CO2 in the limestone 31005% limestone in cement

NOTE A2.1—For example, where the determined CO2 content in the finished cement=1.5% and the CO2 content of the limestone=43% (CaCO3 in limestone=98%), then: 1.5 43 31005 3.5% limestone content in cement A2.2 This specification requires that the limestone to be used must contain a minimum of 70% CaCO3. The manufacturer shall include the CaCO3 content of the limestone on the manufacturer's report. Calculate the CaCO3 content of the limestone as follows: % CaCO3=2.274×% CO2.

NOTE A2.2—For verification of limestone content of cement, the purchaser must analyze for CO2 content and make a correction for the content of CaCO3 in the limestone in order for the data to be comparable to the manufacturer's report.

A2.3 Portland cements that do not contain limestone can contain baseline levels of CO2 inherent in manufacture, for example, due to carbonation. This baseline CO2 content is included as part of any calculated limestone content.

### APPENDIX

### Nonmandatory Information

### X1. MANUFACTURER'S CERTIFICATION (MILL TEST REPORT)

X1.1 To provide uniformity for reporting the results of tests performed on cements under this specification, as required by Section 15 of Specification C150/C150M entitled “Manufacturer's Certification,” an example Mill Test Report is shown in Fig. X1.1.

X1.2 The identity information given should unambiguously identify the cement production represented by the Mill Test Report and may vary depending upon the manufacturer's designation and purchaser's requirements.

X1.3 The Manufacturer's Certification statement may vary depending upon the manufacturer's procurement order, or legal requirements, but should certify that the cement shipped is represented by the certificate and that the cement conforms to applicable requirements of the specification at the time it was tested (or retested) or shipped.

X1.4 The sample Mill Test Report has been developed to reflect the chemical and physical requirements of this specification and recommends reporting all analyses and tests normally performed on cements meeting Specification C150/C150M. Purchaser reporting requirements should govern if different from normal reporting by the manufacturer or from those recommended here.

X1.5 Cements may be shipped prior to later-age test data being available. In such cases, the test value may be left blank.

Alternatively, the manufacturer can generally provide estimates based on historical production data. The report should indicate if such estimates are provided.

X1.6 In reporting limits from the tables in Specification C150/C150M on the Mill Test Report, only those limits specifically applicable should be listed. In some cases, Specification C150/C150M table limits are superceded by other provisions.

X1.7 When limestone or inorganic processing additions or both are used in the cement, additional data are reported by the manufacturer. An example additional data report is shown in Fig. X1.2.

### SUMMARY OF CHANGES

Committee C01 has identified the location of selected changes to this standard since the last issue (C150/C150M—21) that may impact the use of this standard. (Approved Jul. 1, 2022.) (1) Removed references to Test Method C151/C151M from 2.1, Table 3, 9.1.4, and Fig. X1.1. Committee CO1 has identified the location of selected changes to this standard since the last issue (C150/C150M—20) that may impact the use of this standard. (Approved Jul. 15, 2021.) (1) Revised 1.1.1. (2) Revised A1.6.1 and A1.6.2.

### CSA—Hydraulic Binder Made With Calcium Sulfoaluminate Clinker

Buzzi Unicem USA produces a hydraulic binder based on calcium sulfoaluminate clinker obtained by burning a mix of bauxite, gypsum and limestone at a temperature of approximately 2,400° F. CSA contains CSA clinker and anhydrite at the optimal ratio for most uses. In the products where it is added, CSA guarantees constant performances over time and excellent stability in terms of durability. CSA can be used as a quick binder or in combination with Portland cement to obtain products characterized by low shrinkage rate and quick development of strength in short curing periods. CSA allows to formulate products with a wide range of performance, since it is compatible with all types of additives that regulate setting time, plasticity, viscosity, expansion, etc. CSA gives to the products where it is used excellent durability, low permeability to aggressive substances and extremely high resistance to sulfate attacks.

### Applications

CSA can be used by itself or in combination with Portland cement in a large number of applications typical of the pre-mix dry mortar and small precast industry, high strength mortar and tiles adhesives.
Quick-hardening pre-mix plasters, dry mortar and concrete.
Pre-mix dry mortar and concrete for applications at low temperatures.
Pre-mix dry mortar and concrete with low permeability and high resistance to sulfates.
Pre-mix dry mortar and concrete packaged in bags, retain their performances after the package has been opened for a longer time compared to the same products made with calcium alumina cements.
Injection and shotcrete products.
Latest-generation self-levelling screeds.
Quick-drying self-levelling screeds.
Self-levelling screeds with low Alkali-Silica Reaction (ASR) risk.
Self-levelling screeds subject to sulfate attack or to freezing and thawing cycles.
Small precast elements that must be quickly demoulded.
Small precast elements of any color.
Small precast elements with high resistance to sulfates and to freezing and thawing cycles.

### Warnings

When developing different formulations of ternary binders it is recommended to maintain the CSA in Portland cement in percentages included between 40% and 60%(in weight) of the total binder.

By changing the retarder (citric or tartaric acid) or the lithium carbonate accelerator, setting time and strength development will change.

If CSA is used as accelerator of Portland cement, it must be added in a percentage between 10% and 20% of the total binder in order to obtain satisfactory results. The use of CSA is not recommended for the production of products exposed to extremely high temperatures, such as refractory or mortars used to build ovens or similar products.
CSA can be supplied in bulk, in 50 lb. bags, in 2,000 lb. super sacks or bulk.
For additional information, it is recommended to read the user manual of CSA.
Consult the safety data sheet, which can be downloaded from the website:

www.buzzinicemusa.com

### R+D HyCon® S 7042 F

Strength development accelerator in powder form for dry mortar products based on Ordinary Portland Cement

### Characteristics/Chemistry

R+D HyCon® S 7042 F is a hardening accelerator in powder form based on calcium silicate hydrate.

### Fields of Application

R+D HyCon® S 7042 F is especially optimized for acceleration of high early strength development of flowable and non-sag dry mortar products based on Ordinary Portland Cement (OPC), e.g.
repair mortars
cementitious tile adhesives (CTA)
self-levelling underlayments (SLUs)
self-levelling decorative overlayments (SLOs)
self-levelling industrial floors
flowable floor screeds
conventional cementitious floor screeds (non-flowable)
non-shrink grouts (machinery grouts)
injection mortars

### Technical Data

Physical shape powder
Appearance white to off-white
Drying loss, [%] max. 2.0
Bulk density, [kg/m³] 600 to 1.000
pH-value (20° C.), 20% in water 11.5 to 13
Alkali content Na 20+K 20 [%] max. 0.5
Dosage recommendation, [%]
in relation to weight of dry mortar 0.5 to 2.0

### Further Technical Data

Packaging 15 kg paper bags
Storage to be stored in its unopened original packaging, store dry below 40° C. and protect from excessive heat;
protect from moisture (see annex)
Shelf life 1 year
Storage class 13 (non-combustible solids)
Transport regulation not known as a dangerous good according to transport regulations

### Safety Notes

Comprehensive instructions are given in the corresponding Material Safety Data Sheets which are available on request.

Annex storage and handling:

HyCon ® S 7042 F is a hygroscopic product that absorbs water quickly if wrongly stored. Attention is required in order to avoid the exposed surface with air humidity.

HyCon ® S 7042 F might contain lumps <1 cm. The lumps do not have any effect on the performance of the product.

Absorption of humidity can be avoided:
1. By preserving the product in closed containers
2. By preparing the possible pre-mixture just when it is used
3. By avoiding high relative humidity in the working environment

HyCon ® S 7042 F does not contain preservatives and it is stable if stored in its original packaging or in suitable sealed containers.

Especially when performing lab tests, it is important that the sample containers are closed immediately after sampling.

The product is a sales product at experimental stage (“R+D Test Product”) for which development and testing have not been completed yet. Further information, including amended or supplementary data, may be compiled in the future. For this reason, no assurances are given as to type conformity, processability, long-term performance characteristics or other production or application parameters. Inter alia, chemistry (raw materials) and composition/recipe of the R+D Test Product may be changed, and its production may be discontinued even without giving reasons. To the extent legally permissible, the R+D Test Product is made available without (express and implied) guarantee, warranty or liability. No warranty is given for the performance of the product during usage and processing. The customer shall bear the risk of using the R+D Test Product.

### Standard Specification for

### Packaged, Dry, Rapid-Hardening Cementitious Materials for

### Concrete Repairs1

This standard is issued under the fixed designation C928/C928M; the number immediately following the designation indicates the year of original adoption or, in the case of revision, the year of last revision. A number in parentheses indicates the year of last reapproval.

A superscript epsilon (') indicates an editorial change since the last revision or reapproval.

### 1. Scope*

1.1 This specification covers packaged, dry, cementitious mortar or concrete materials for rapid repairs to hardened hydraulic-cement concrete pavements and structures. Materials that contain organic compounds, such as bitumens, epoxy resins, and polymers, as the principal binder are not included.

1.1.1 Packaged, dry, concrete material contains aggregate of which at least 5% by mass of the total mixture is retained on a 9.5-mm [⅜-in.] sieve.

1.1.2 Packaged, dry, mortar material contains aggregate of which less than 5% by mass of the total mixture is retained on a 9.5-mm [⅜-in.] sieve.

1.2 Aqueous solutions, aqueous emulsions or dispersions may be included as components of the packaged materials. The manufacturer may specify that these liquids are to replace some or all of the mixing water.

1.3 Aggregates must be included as a component of the packaged materials. The manufacturer may recommend job site addition of specific amounts and types of additional aggregates to his product for some uses. However, such reformulated products are not within the scope of this specification.

1.4 The values stated in either SI units or inch-pound units are to be regarded separately as standard. The values stated in each system may not be exact equivalents; therefore, each system shall be used independently of the other. Combining values from the two systems may result in non-conformance with the standard.

1.5 The following safety hazards caveat pertains to the test methods portion of this specification: This standard does not purport to address all of the safety concerns, if any, associated with its use. It is the responsibility of the user of this standard to establish appropriate safety, health, and environmental practices and determine the applicability of regulatory limitations prior to use.

1.6 This international standard was developed in accordance with internationally recognized principles on standardization established in the Decision on Principles for the Development of International Standards, Guides and Recommendations issued by the World Trade Organization Technical

Barriers to Trade (TBT) Committee.

### 2. Referenced Documents

2.1 ASTM Standards:2

C39/C39M Test Method for Compressive Strength of Cylindrical Concrete Specimens C78 Test Method for Flexural Strength of Concrete (Using Simple Beam with Third-Point Loading)

C109/C109M Test Method for Compressive Strength of Hydraulic Cement Mortars (Using 2-in. or [50 mm] Cube Specimens)

C125 Terminology Relating to Concrete and Concrete Aggregates C143/C143M Test Method for Slump of Hydraulic-Cement Concrete

C157/C157M Test Method for Length Change of Hardened Hydraulic-Cement Mortar and Concrete

C192/C192M Practice for Making and Curing Concrete Test Specimens in the Laboratory

C403/C403M Test Method for Time of Setting of Concrete Mixtures by Penetration Resistance

C490/C490M Practice for Use of Apparatus for the Determination of Length Change of Hardened Cement Paste, Mortar, and Concrete C494/C494M Specification for Chemical Admixtures for Concrete

C666/C666M Test Method for Resistance of Concrete to Rapid Freezing and Thawing C670 Practice for Preparing Precision and Bias Statements for Test Methods for Construction Materials

C672/C672M Test Method for Scaling Resistance of Concrete Surfaces Exposed to Deicing Chemicals

C702 Practice for Reducing Samples of Aggregate to Testing Size

C778 Specification for Standard Sand

C882 Test Method for Bond Strength of Epoxy-Resin Systems Used With Concrete By Slant Shear

C1012 Test Method for Length Change of Hydraulic-Cement Mortars Exposed to a Sulfate Solution

E96/E96M Test Methods for Water Vapor Transmission of Materials

### 3. Terminology

3.1 Definitions—For definitions of terms used in this specification refer to Terminology C125.

### 4. Materials and Manufacture

4.1 Three types of packaged, dry, rapid-hardening concrete and three types of packaged, dry, rapid-hardening mortar are identified in Table 1.

### 5. Chemical Composition

5.1 If the material contains soluble chlorides or other ingredients in sufficient quantity to cause corrosion to steel reinforcement, the package markings shall contain the following statement in letter size no smaller than the directions for use:

This material is not recommended for use in a moist environment in contact with steel reinforcement.

5.1.1 Consider a total chloride ion content (Berman, 1972)3,4 in the packaged repair material greater than 600 g/m3 [1 lb/yd3] of the hardened repair material indicative that the packaged material contains sufficient chlorides to cause corrosion to steel reinforcement when the concrete is exposed to weather, is on the ground, or is in an otherwise moist environment. A much lower chloride ion content is suggested for use in prestressed concrete. Guidance for such users is outside the scope of this specification.

5.2 If the material contains metallic iron in excess of 1% by weight, the package markings shall contain the following statement in letter size no smaller than the directions for use:

If small or scattered spots of iron-staining are considered objectionable, do not use this material where it will be exposed.

### 6. Performance Requirements

6.1 The materials shall comply with the performance requirements in Table 1 for the applicable type.

TABLE 1
Performance Requirements

[symbol]

| | 3 h | 1 day | 7 days | 28 days |
|---|---|---|---|---|
| Compressive Strength, min, [symbol] [symbol] | | | | |
| R1 [symbol] | 3.5 [500] | 14 [2000] | 28 [4000] | [symbol] |
| R2 [symbol] | 7.0 [1000] | 21 [3000] | 28 [4000] | [symbol] |
| R3 [symbol] | 21 [3500] | 35 [5000] | 35 [5000] | [symbol] |
| Bond [symbol] , min, | | | | |
| R1, R2, and R3 [symbol] | — | 7 [1000] | 10 [1500] | — |
| Length [symbol] , based on length at 3 h, [symbol] | [symbol] increase after [symbol] | | | +0.15 |
| | days in water | | | |
| R1, R2, and R3 [symbol] | [symbol] decrease after [symbol] | | | −0.15 |
| | days in air | | | |
| [symbol] | | | [symbol] | [symbol] |
| | | | [symbol] | [symbol] |
| R1 [symbol] after 15 [symbol] after [symbol] of | | | 75 [ [symbol] ] | 100 |
| mixing liquid | | | | |
| R2 and R3 [symbol] at 5 [symbol] after [symbol] of | | | 75 [ [symbol] ] | 100 |
| mixing liquid | | | | |
| [symbol] after 25 cycles of freezing and | | | | |
| thawing | | | | |
| [symbol] max visual rating | | | 2.5 | |
| [symbol] | | | 5 [symbol] [symbol] | |

[symbol]

[symbol]

Time of [symbol] Test Method [symbol] [symbol]
strength Test Method [symbol]
Freeze thaw Test Method [symbol] Procedure A [symbol]
Test Method [symbol] [symbol]
The strength at 28 days [symbol] be not [symbol] the strength at 7 days [symbol] [symbol]
or flow [symbol] [symbol] [symbol]
for 100% of its surface would have about 10 [symbol] [symbol]
indicates data missing or illegible when filed

### 7. Sampling

7.1 A lot is the quantity of packaged repair material normally placed on a pallet. In general, this quantity will weigh from 900 to 1800 kg [2000 to 4000 lb].

7.2 A unit sample is a single package of material randomly selected from the lot.

### 8. Specimen Preparation

8.1 Concrete Mechanically mix the packaged dry concrete material with mixing liquid. Determine the properties of the unhardened mixture, and mold and cure the specimens in accordance with Practice C192/C192M or modifications as outlined herein.

8.1.1 The sample of packaged dry material shall be any combination of whole packages yielding not less than 20 L [⅔ ft3] of hardened material.

8.1.2 Base the quantity of water, other liquid component, or both added to the sample on the quantity per bag stated in the directions for use.

8.1.3 Place the sample in the mixing machine and add the required amount of liquid. Start mixing immediately. Continue mixing for the length of time indicated in the directions for use.

8.1.4 When making the slump test in accordance with Test Method C143/C143M, schedule work so the test will be completed in 5 6 ½ min after the mixing liquid is added to the R2 or R3 materials or 15 6 ½ min after mixing the liquid with the R1 materials.

8.1.5 Mold the required number of specimens using additional samples as may be necessary, mixed in accordance with 8.1.1—8.1.4. Do not use the mixtures for molding test specimens when the slump is less than that specified in Table 1.

NOTE 1—Where the nominal maximum particle size is not greater than 25 mm [1 in.], the use of cylindrical molds 100 mm [4 in.] in diameter by 200 mm [8 in.] in length is suggested.

8.2 Mortar Mechanically mix packaged dry mortar material with mixing liquid. Determine the properties of the unhardened mixture, and mold and cure the specimens in accordance with Test Method C109/C109M or modifications as outlined herein.

8.2.1 The sample of packaged dry material shall weigh 3000 6 3 g [6.6 6 0.005 lb] and shall be representatively obtained from a whole package in accordance with Practice C702.

8.2.2 Base the quantity of water, or other liquid component, or both added during mixing on the quantity per unit of weight stated in the directions for use.

8.2.3 When making the flow test in accordance with the section on consistency in Test Method C109/C109M, schedule work so the test will be completed in 5 6 ½ min after the start of mixing liquid with the R2 or R3 materials or 15 6 ½ min after mixing the liquid with the R1 materials.

8.2.4 Mold the required number of specimens using additional samples as necessary mixed in accordance with 8.2.1—

8.2.3. Do not use the mixtures for molding test specimens when the flow is less than that specified in Table 1.

8.3 In those cases where the manufacturer has indicated in the package markings, or elsewhere, that the packaged repair material can be mixed and applied at temperatures that lie beyond the range of 20 6 8° C. [70 6 15° F.], the product must meet the requirements of Table 1. Specimens must be made and cured in accordance with the procedures of this section.

The mixing, molding and curing temperatures during the first 3 h after molding shall be within 61° C. [62° F.] of the extreme temperature(s) stated by the manufacturer in the package markings.

### 9. Test Methods

9.1 Manifestly Faulty Specimens Treat manifestly faulty specimens in accordance with the corresponding section in Specification C494/C494M.

9.2 Compressive Strength Prepare and test three test specimens for each age of test and each level of mixing temperature. Test in accordance with Test Method C39/C39M for concrete and Test Method C109/C109M for mortar.

9.3 Length Change Prepare and test three specimens (set) in accordance with Test Method C157/C157M, except as modified by this section and 8.3. The molds for casting test specimens and the length comparator shall comply with the requirements of Practice C490/C490M.

9.3.1 Preparation of Specimen Molds and Material Conditioning The temperature of the mixing water and the materials used to prepare the test specimens shall be 23 6 2.0° C. [73.5 6 3.5° F.] except as modified by 8.3. The air temperature of the mixing room, molds and base plates shall be maintained at 23 6 2.0° C. [73.5 6 3.5° F.] and at a relative humidity of not less than 50% except if modified by 8.3. Prepare the specimen molds in accordance with the requirements of Practice C490/C490M. Mold dimensions shall be at least three times the nominal aggregate size. The test specimen for mortar shall be a prism of 25-mm [1-in.] square crosssection and approximately 285-mm [11 ¼-in.] in length. The test specimen for concrete, which all the aggregate passes a 50-mm [2-in.] sieve, shall be a prism of 100-mm [4-in.] square cross-section and approximately 285-mm [11 ¼-in.] long.

However, a prism of 75-mm [3-in.] square cross-section shall be used if all the aggregate passes a 25-mm [1-in.] sieve and a 50-mm [2-in.] square cross-section shall be used if all aggregates passes a 13-mm [½-in.] sieve.

9.3.2 Initial Curing and Demolding of Test Specimens

Cure the test specimens in the molds at 23 6 2.0° C. [73.5 6 3.5° F.] and not less than 50% relative humidity except if modified by 8.3. Remove specimens from the molds at an age of 23/4 to 3 h after the addition of mixing liquid to the dry cementitious mixture during the mixing operation.

9.3.3 Make the initial comparator measurement reading of length at 3 to 3 ¼ h after the addition of mixing liquid to the dry cementitious mixture during the mixing operation. If specimens are cured at temperatures other than 23 6 2.0° C. [73.5 6 3.5° F.], then both initial and final length measurements shall be made with the bars conditioned to 62.0° C. [63.5° F.] of initial temperatures.

9.3.4 Curing of Test Specimens After making the initial comparator reading, immediately store one set of specimens as for “Air Storage” and one set as for “Water Storage” within 10 min of reading.

9.3.4.1 Air Storage Store the specimens in a dry room so that the specimens have a clearance of at least 25 mm [1 in.] on all sides and the room is maintained at a relative humidity of 50 6 4% and a temperature of 23 6 2.0° C. [73.5 6 3.5° F.] except if modified by 8.3.

9.3.4.2 Water Storage Water-stored specimens shall be completely submerged in untreated tap water with no more than one set of specimens per container at a temperature of 23 6 2.0° C. [73.5 6 3.5° F.] except if modified by 8.3.

9.3.5 Final Comparator Reading Measure the length at an age of 28 days 6 20 h. For specimens stored in water, remove the specimens from water storage one at a time, remove surface moisture and take the comparator reading within 15 s of removing from water. Determine the average percent change in length of specimens.

9.4 Scaling Resistance Make and cure the test specimens in accordance with Test Method C672/C672M, except as provided herein. For specimens of mortar omit the visual rating procedure after every 5 cycles and after 25 cycles determine the amount of scaling as the oven dry 110 6 5° C. [230 6 9° F.] mass per unit area of exposed test area.

9.5 Slant Shear Bond Strength Prepare six complete test specimens in accordance with Test Method C882 for Type II and V systems except as modified by this section.

9.5.1 Do not apply a bonding system to prepared surface unless a bonding system is required by the manufacturer of the rapid-hardening cementitious material. Fill the top half of the cylinder with the rapid-hardening cementitious material instead of the portland cement mortar specified.

9.5.2 Test three specimens in compression at 1 day and three at 7 days. Calculate the bond strength on the elliptical area and report the failure type.

### 10. Report

10.1 Report the following:

10.1.1 Source and identification, including type, of material tested,

10.1.2 Details of any variations and options practiced by the tester that are recommended or allowed by the manufacturer or others, 10.1.3 Compressive strength of material at 3 h, 1 day, 7 days and 28 days,

10.1.4 Bond strength at 1 day and 7 days,

10.1.5 Percent length change at 28 days in water and in air,

10.1.6 Percent flow in mortar at 5 or 15 min,

10.1.7 Slump in concrete at 5 or 15 min, and

10.1.8 Scaling resistance after 25 cycles.

### 11. Precision and Bias

11.1 Length Change:

11.1.1 Precision The precision of the length change test method described in section 9.3 is based on an interlaboratory study that was conducted in 2007.5 Seven laboratories tested one rapid-hardening material that consisted of commercially available rapid hardening cement blended with three parts standard graded sand complying with Specification C778. The precision values were calculated for both “water storage” and “air storage” of test specimens. A test result is defined in this specification as the average of three separate measurements (triplicate length change specimens).

11.1.2 The single-operator standard deviation for water storage of test specimens has been found to be 0.0031%.6 Therefore, results of two properly conducted tests by the same operator on the same material are not expected to differ by more than 0.009%.6 The single-operator standard deviation for air storage of test specimens has been found to be 0.0067%.6 Therefore, results of two properly conducted tests by the same operator on the same material are not expected to differ by more than 0.019%.6

11.1.3 The multi-laboratory standard deviation for water storage of test specimens has been found to be 0.0078%.6 Therefore, results of two properly conducted tests from two different laboratories on the same material are not expected to differ by more than 0.022%.6 The multilaboratory standard deviation for air storage of test specimens has been found to be 0.015%.6 Therefore, results of two properly conducted tests from two different laboratories on the same material are not expected to differ by more than 0.041%.6

11.1.4 Bias Since there is no accepted reference material suitable for determining any bias that might be associated with this test method, no statement on bias is being made.

### 12. Rejection

12.1 The purchaser has the right to reject material that fails to conform to the requirements of this specification. Rejection shall be reported to the producer or supplier in writing.

### 13. Certification

13.1 When specified in the purchase order or contract, a producer, supplier, or an independent testing laboratory shall furnish certification to the purchaser that the material has been tested in accordance with this specification and found to meet the requirements. When specified in the purchase order or contract, a report of test results on samples taken from material shipped shall be furnished.

### 14. Product Marking

14.1 Mark all packages to contain the following information:

14.1.1 Specification designation.

14.1.2 R1 or R2 or R3 type.

14.1.3 Directions for use that shall include but are not limited to:

14.1.3.1 When a bonding agent is used in the test of bond strength, the type and kind of adhesive recommended to bond fresh repair material to the concrete or mortar being repaired. 14.1.3.2 The recommended amount of water, other liquid component, or both, to be mixed with the package contents.

14.1.3.3 The recommended length of mixing time or sequence of mixing and resting times in minutes.

14.1.4 Date the material was packaged.

14.1.5 The yield in litres [cubic feet] or yield in square metres per centimetre [square feet per inch] thickness when mixed with the recommended amount of liquid.

14.1.6 If the product is formulated for use in vertical or overhead applications, it shall be so stated on the package.

### 15. Packaging

15.1 The material from which the containers are made shall have water vapor transmission not greater than 100 g/m2 [0.2 lb/ft3] in 24 h as determined in accordance with Procedure B of Test Methods E96/E96M.

### 16. Package Mass and Condition

16.1 The average net mass of packages for any shipment shall not be less than the net mass printed on the package.

16.2 The net mass of an individual package shall not be more than 2% higher nor 2% lower than the net mass printed on the package, unless otherwise required by government regulations or stated in purchase documents.

NOTE 2—United States and Canadian government regulations describe the sampling of packages for determination of the average net mass in a lot. Government regulations also describe the allowed variation in the net mass of individual packages from the value printed on the package.

NOTE 3—In the United States, requirements for the net mass of packages are commonly governed by state law based on NIST Handbook 133. NIST HB 133 describes the sampling of lots for the determination of average net mass and the requirement that average net mass for a lot meet or exceed the printed package net mass. NIST HB 133 also describes the maximum allowable variation of individual packages from the printed package net mass. NIST HB 133 is available from the National Institute of Standards and Technology (NIST) at https://www.nist.gov/pml/weights-and-measures/publications/nist-handbooks/handbook-133 (as of Jan. 10, 2020). “Maximum Allowable Variations (MAVs) for Packages Labeled by Weight” are listed in Table 2-5 of this handbook. The MAVs are not defined as a single percentage value. Instead they are defined as a specific mass for a defined range of contents. The MAVs range from approximately 3% for a 3-lb package to 1% for a 50-lb package to 2% for packages of 55 lb and more. If not stated in the purchase documents, applicable regulations should be confirmed and complied with by the manufacturer.

NOTE 4—In Canada, accuracy for the average net contents and the tolerances for individual package contents are specified in the Consumer Packaging and Labelling Regulations (C.R.C., c.417). These regulations are available from the Government of Canada at https://lawslois. justice.gc.ca/eng/regulations/C.R.C.%2C_c._417/index.html (as of Jan. 10, 2020). Schedule I, PART III provides “Tolerances for Net Quantities Declared in Metric Units of Mass or Volume for Prepackaged Products other than Catch Weight Products” and PART IV provides tolerances in Canadian Units. Current Canadian regulations define an allowed tolerance of 1.5% for packages containing between 1 kg and 10 kg, 1% for packages greater than 15 kg. Other tolerances are defined for other masses. Schedule II describes sampling and determining the average net contents in a sample. If not stated in the purchase documents, applicable regulations should be confirmed and complied with by the manufacturer.

16.3 Packages shall be provided undamaged such that all product can be used.

### 17. Keywords

17.1 cementitious mortar or concrete materials for repair; concrete; packaged; mortar; packaged; packaged dry materials for concrete repair; rapid hardening materials; repair materials

### SUMMARY OF CHANGES

Committee C09 has identified the location of selected changes to this standard since the last issue (C928/C928M—20) that may impact the use of this standard. (Approved Sep. 1, 2020.)
(1) Section 16 on Package Mass and Condition was revised extensively to improve language. Committee C09 has identified the location of selected changes to this standard since the last issue (C928/C928M—19) that may impact the use of this standard. (Approved Jan. 1, 2020.)

(1) Explained what guideline the molds must meet in section 9.3.
(2) Added to existing sections 9.3.1, 9.3.2, and 9.3.3 to provide more description of test temperature conditions and time.
(3) Added to existing section 9.3.4 and new sections 9.3.4.1 and 9.3.4.2 were added to provide more description on curing of test specimens.
(4) New section 9.3.5 was added to provide more description on how to take the final comparator reading. Committee C09 has identified the location of selected changes to this standard since the last issue (C928/C928M—13) that may impact the use of this standard. (Approved Dec. 1, 2019.)
(1) The basis of rejection (Section 12) has been updated to conform to text recommended by C09.95 Coordination.
(2) The basis of rejection has been updated to conform with the Weights and Measures regulations utilized in commerce, including NIST in the US and the Canadian Consumer Packaging and Labelling Regulations.
(3) Deleted previous 14.1.6.

Melment F 10

Chemical Nature Melment F 10 is free-flowing spray dried powder of a sulphonated polycondensation product based on melamine. Superplasticizer for cement and calcium sulphate based materials.

Properties

Typical Properties

Physical shape powder

Appearance characteristic, white to slightly colored

Drying loss max. 4.0%

Bulk density 500—800 kg/m 3

Dosage recommendation 0.20—2.00%

by weight of cementitious materials

pH value at 20° C., 20% solution 9.0—11.4

Applications

Fields of application Melment F 10 is especially optimized for plastification and water reduction of cement and calcium sulphate based materials; including the following:

Self-leveling underlayments (SLU)

Feather edge products

Cementitious floor screeds

Dry-mix concrete

Repair mortars

Non-shrink grouts

Cementitious self leveling floor screeds

Tile adhesives and joint fillers

Safety

General The usual safety precautions when handling chemicals must be observed. These include the measures described in Federal, State and Local health and safety regulations, thorough ventilation of the workplace, good skin care and wearing of protective goggles.

Material Safety Data Sheet All safety information is provided in the Material Safety Data Sheet for Melment F 10.

Transport Regulation Not known as a dangerous good according to transport regulations.

1. A formulation for a packaged, dry, cementitious concrete material for rapid repairs to hardened hydraulic-cement concrete pavements, structures, and other articles, that meets or exceeds the performance requirements of ASTM C928/C928M—20a for a type R3 concrete to be mixed and applied at or below 32° F., said formulation comprising:
a. calcium sulfoaluminate cement; and
b. a hardening accelerator that operates by contributing seeds of calcium-silicate-hydrate when the dry cementitious concrete material is mixed with water.

2. The formulation of claim 1 that meets or exceeds the performance requirements of ASTM C928/C928M—20a for a type R3 concrete to be mixed and applied at 0° F.

3. The formulation of claim 2 that includes no Portland cement.
